(19) United States
(12) Patent Application Publication
(10) Pub. No.: US 2019/0001244 A1
(43) Pub. Date: Jan. 3, 2019

(54) FILTERING DEVICE

(71) Applicant: ASIA IC MIC-PROCESS, INC., Hsinchu (TW)

(72) Inventor: Hung-Hsin HSU, Qionglin Township (TW)

(21) Appl. No.: 16/025,221

(22) Filed: Jul. 2, 2018

Related U.S. Application Data
(60) Provisional application No. 62/528,247, filed on Jul. 3, 2017.

(51) Int. Cl. B01D 35/30; B01D 29/15; B01D 36/00

(52) U.S. Cl. CPC B01D 35/30; B01D 29/15; B01D 2201/16; B01D 2201/0415; B01D 36/001

(57) ABSTRACT

A filtering device includes a base assembly, a valve assembly, a lock assembly and a filter assembly. The valve assembly comprises an end connected to the base assembly and in communication with the input tube and the output tube, and comprises other end formed with an opening. The lock assembly has a groove part. The filter assembly includes an end protruding outwardly to form a connection part, and other end protruding outwardly to form a fastening part. The filter assembly is movably combined in the groove part by connection part, so as to combine with the lock assembly. When the filter assembly is accommodated inside the valve assembly and the lock assembly is combine to the opening, the lock assembly can drive the fastening part of the filter assembly to combine with the base assembly, so as to fix the filter assembly in the valve assembly.

### CROSS-REFERENCE TO RELATED APPLICATION

This application claims the benefit of U.S. Provisional Application No. 62/528,247, filed on Jul. 3, 2017, in the United States Patent and Trademark Office, the disclosure of which is incorporated herein in their entirety by reference.

### BACKGROUND OF THE INVENTION

### 1. Field of the Invention

The present invention relates to a filtering device, more particularly to a filtering device which includes a modularized valve and is able to replace a filter element without detaching a base or a tube thereof.

### 2. Description of the Related Art

In recent years, the existing filtering devices mainly include a valve body and a filter element. The filter element is accommodated in a shell member, and the bottom of the valve body is connected with a base which is in communication with a tube of an external water source and the filter element. The filter element can be used to filter impurities and remove odors.

However, because of the narrow installation space of the filtering device, the filter element must be detached from the bottom of the filtering device for replacement. Therefore, in order to facilitate the replacement of the filter element by the operator, a large amount of space is required for installation of the filter device, and a lot of blind spots are formed by in the tube and the filtering device.

### SUMMARY OF THE INVENTION

In order to solve the aforementioned technical problems, the present invention provides a filtering device.

According to an embodiment, the present invention provides a filtering device comprising a base assembly, a valve assembly, a lock assembly and a filter assembly. The base assembly is in a hollow structure, and includes an end connected to an input tube, and other end connected to an output tube. The valve assembly is in a tubular structure, and includes an end connected to the base assembly and in communication with the input tube and the output tube, and other end formed with an opening. The lock assembly includes a groove part. The filter assembly includes an end protruding outwardly to form a connection part, and other end protruding outwardly to form a fastening part. The filter assembly is movably combined in the groove part by the connection part, so as to combine with the lock assembly. When the filter assembly is accommodated inside the valve assembly and the lock assembly is combined with the opening, the lock assembly can drive the fastening part of the filter assembly to combine with the base assembly, so that the filter assembly can be fixed in the valve assembly.

Preferably, the base assembly comprises a lock part, and when the filter assembly is accommodated inside the valve assembly and the lock assembly is combined with the opening, the lock assembly drives the fastening part of the filter assembly to combine with the lock part of the base assembly.

Preferably, when the lock assembly is separated from the opening, the lock assembly drives the fastening part of the filter assembly to separate from the lock part.

Preferably, the fastening part comprises a first combination structure, the lock part comprises a second combination structure, and the filter assembly is movably combined with or separated from the second combination structure by the first combination structure, so as to combine with or separate from the base assembly.

Preferably, the filter assembly is a filter element.

Preferably, the lock assembly comprises a third combination structure formed at a side thereof, the valve assembly comprises a fourth combination structure formed on an internal wall of the opening and correspondingly in position to the third combination structure, and the lock assembly is movably combined with or separated from the fourth combination structure by the third combination structure, so as to combine with or separate from the valve assembly.

According to above-mentioned content, the filtering device of the present invention can be directly fastened with the base assembly by the valve assembly, so that the filter element can be directly pulled out from the upper end of the valve assembly, to achieve modularization of the valve assembly and the base assembly, and facilitate the operator in replacing the filter element, thereby reducing blind spot to save the occupied space.

### BRIEF DESCRIPTION OF THE DRAWINGS

The structure, operating principle and effects of the present invention will be described in detail by way of various embodiments which are illustrated in the accompanying drawings.

FIG. 1 is a first schematic structural view of a filtering device of a first embodiment of the present invention.

FIG. 2 is a second schematic structural view of a filtering device of a first embodiment of the present invention.

FIG. 3 is a third schematic structural view of a filtering device of a first embodiment of the present invention.

FIG. 4 is a schematic structural view of a filtering device of a second embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

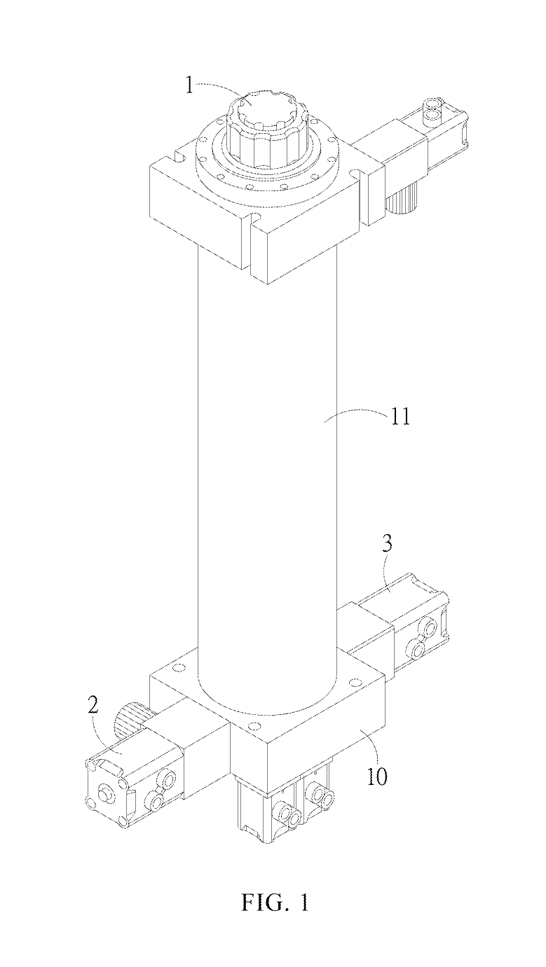

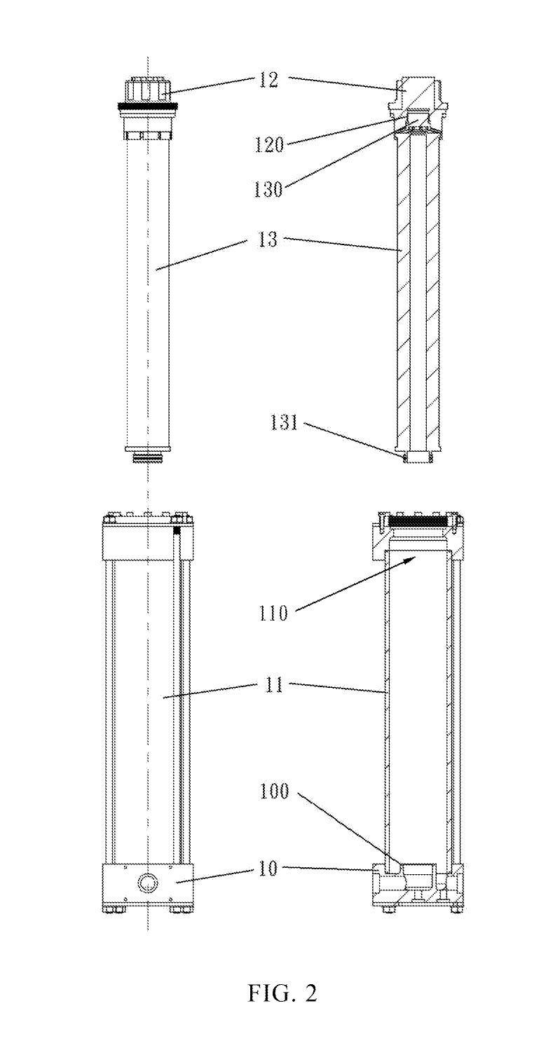

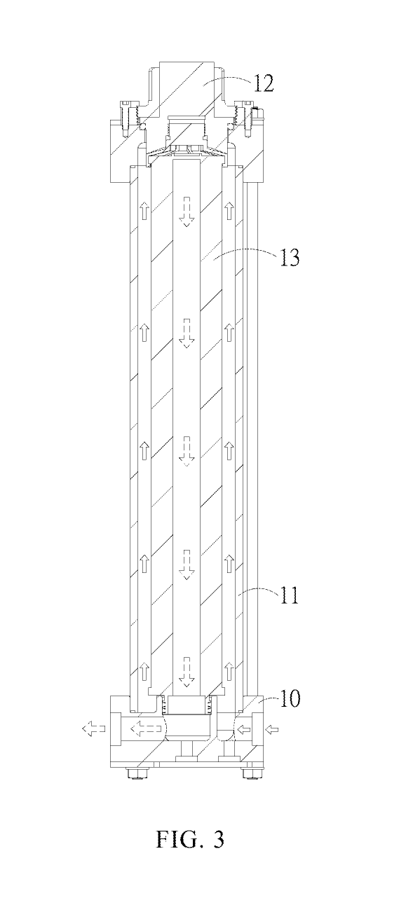

Please refer to FIGS. 1 to 3, which are first to third schematic structural views of a filtering device of a first embodiment of the present invention, respectively. As shown in figure, the filtering device 1 comprises a base assembly 10, a valve assembly 11, a lock assembly 12 and a filter assembly 13. The base assembly 10 is in a hollow structure, and comprises an end connected to an input tube 2, and other end connected to an output tube 3. The valve assembly 11 is in a tubular structure, and comprises an end connected to the base assembly 10 and in communication with the input tube 2 and the output tube 3, and other end formed with an opening 110. The lock assembly 12 has a groove part 120. The filter assembly 13 includes an end protruding outwardly to form a connection part 130, and other end protruding outwardly to form a fastening part 131. The filter assembly 13 is movably combined in the groove part 120 by the connection part 130, so as to combine with the lock assembly 12. When the filter assembly 13 is accommodated inside the valve assembly 11 and the lock assembly 12 is combined with the opening 110, the lock assembly 12 can drive the fastening part 131 of the filter assembly 13 to combine with the base assembly 10, so as to fix the filter assembly 13 on the valve assembly 11.

In an embodiment, the filtering device 1 includes the base assembly 10, the valve assembly 11, the lock assembly 12 and the filter assembly 13. The base assembly 10 is in a hollow structure having a slight square shape, and the base assembly 10 includes an end connected to the input tube 2 of the external fluid source, and other end connected to the output tube 3 which is configured to flow out the external fluid. The lock assembly 12 is in the hollow tubular structure, and a lower end of the lock assembly 12 is connected to the base assembly 10 and in communication with the inner part of the base assembly 10, and an upper end of the lock assembly 12 comprises the opening 110 configured to lock with the lock assembly 12. The lock assembly 12 can be a slightly non-vertical cylindrical structure, and a bottom of the lock assembly 12 can be formed with a groove part 120. The filter assembly 13 can be the filter element including an end having the connection part 130 and other end having the fastening part 131. In order to install the filtering device 1, the base assembly 10 is connected to the input tube 2 and the output tube 3, the bottom of the valve assembly 11 is connected to the base assembly 10, and the filter assembly 13 is combined with the groove part 120 by the connection part 130, so as to combine with the lock assembly 12. The connection part 130 and the groove part 120 can be combined with each other by a thread engagement manner. Next, the filter assembly 13 is accommodated inside the valve assembly 11, and the lock assembly 12 is combined with the opening 110 of the valve assembly 11. When the lock assembly 12 is combined with the opening 110, the lock assembly 12 is also combined with the filter assembly 13 and the base assembly 10 simultaneously, so as to fix the filter assembly 13 inside the valve assembly 11. For example, in a condition that the lock assembly 12 is rotated to lock with the opening 110, and while the lock assembly 12 is being rotated, the lock assembly 12 also drives the filter assembly 13 to rotate; and, while the lock assembly 12 is being combined with the opening 110 gradually, the filter assembly 13 is also combined with the base assembly 10 gradually.

Further, the base assembly 10 can comprise a lock part 100. When the filter assembly 13 is accommodated inside the valve assembly 11 and the lock assembly 12 is combined with the opening 110, the lock assembly 12 can drive the fastening part 131 of the filter assembly 13 to combine with the lock part 100 of the base assembly 10; and, when the lock assembly 12 is separated from the opening 110, the lock assembly 12 can drive the fastening part 131 of the filter assembly 13 to separate from the lock part 100.

In other words, the base assembly 10 comprises the lock part 100 configured to combine with the fastening part 131. In order to fix the filter assembly 13 in the valve assembly 11, the operator can accommodate the filter assembly 13 inside the valve assembly 11 through the opening 110, and then rotate the lock assembly 12, so as to lock the lock assembly 12 with the opening 110; at this time, the fastening part 131 of the filter assembly 13 can be combined with the lock part 100 of the base assembly 10 gradually. After these two parts (that is, the lock assembly 12 and the opening 110, and the fastening part 131 and lock part 100) are combined with each other, the filter assembly 13 can be stably fixed inside the valve assembly 11 to provide the filtering function.

In order to replace the filter assembly 13, the operator just needs to separate the lock assembly 12 from the top of the valve assembly 11, thereby directly pulling out the filter assembly 13 for replacement. While the lock assembly 12 is gradually being separated from the valve assembly 11, the fastening part 131 of the filter assembly 13 can be also separated from the lock part 100 of the base assembly 10 gradually.

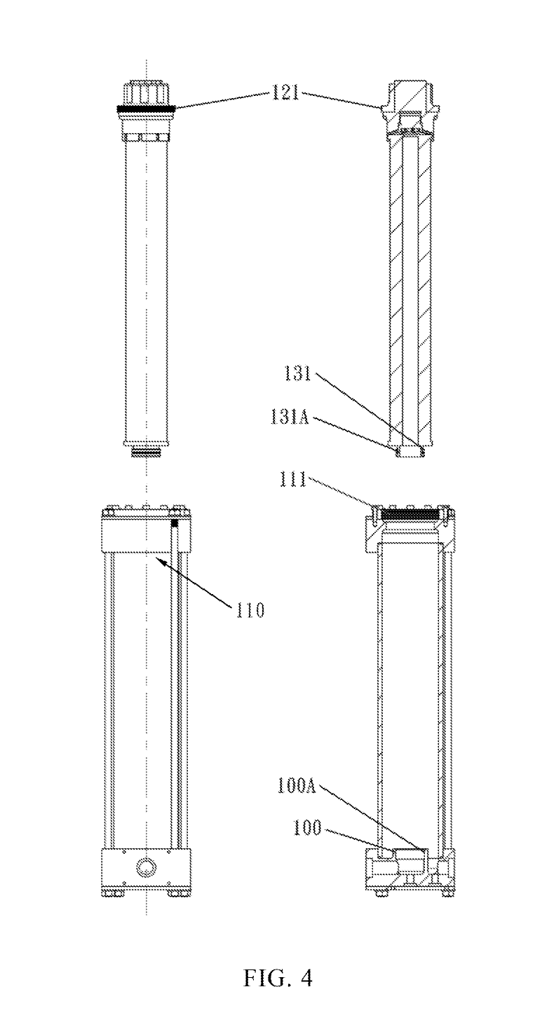

Please refer to FIG. 4, which is a schematic structural view of a filtering device of a second embodiment of the present invention. Please also refer to FIGS. 1 to 3. As shown in figure, the components of the filtering device of this embodiment the same as that of the filtering device of the first embodiment can be operated by similar manners, so their detailed description are not repeated herein. It is worth noting that, in this embodiment, the fastening part 131 has a first combination structure 131A, the lock part 100 have a second combination structure 100A, and the filter assembly 13 is movably combined with or separated from the second combination structure 100A by the first combination structure 131A, so as to combine with or separate from the base assembly 10.

For example, the fastening part 131 of the filter assembly 13 can comprise the first combination structure 131A, such as a thread; and, the lock part 100 of the base assembly 10 can have the second combination structure 100A (such as a thread) corresponding to the fastening part 131. The filter assembly 13 can be combines with the second combination structure 100A by the first combination structure 131A, so as to combine with the base assembly 10; or, the filter assembly 13 can be separated from the second combination structure 100A by the first combination structure 131A, so as to separate from the base assembly 10.

Preferably, the lock assembly 12 can comprise a third combination structure 121 formed at a side thereof, the valve assembly 11 can comprise a fourth combination structure 111 formed on an internal wall of an opening 110, and The lock assembly 12 is movably combines with or separated from the fourth combination structure 111 by the third combination structure 121, so as to combine with or separate from the valve assembly 11.

In other words, the lock assembly 12 can include the third combination structure 121 formed at a side thereof, such as a thread; and, the valve assembly 11 can include the fourth combination structure 111 (such as a thread) formed on the internal wall of the opening 110 and corresponding to the side of the lock assembly 12, so that the lock assembly 12 can be combined with the fourth combination structure 111 through the third combination structure 121, so as to combine with the valve assembly 11; or, the lock assembly 12 can be separated from the fourth combination structure 111 through the third combination structure 121, so as to separate from the valve assembly 11.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A filtering device, comprising:
a base assembly being in a hollow structure, and comprising an end connected to an input tube, and other end connected to an output tube;
a valve assembly being in a tubular structure, and comprising an end connected to the base assembly and in communication with the input tube and the output tube, and comprising other end formed with an opening;
a lock assembly comprising a groove part; and
a filter assembly comprising an end protruding outwardly to form a connection part, and other end protruding outwardly to form a fastening part, wherein the filter assembly is movably combined in the groove part by the connection part, so as to combine with the lock assembly;
wherein when the filter assembly is accommodated inside the valve assembly and the lock assembly is combined with the opening, the lock assembly drives the fastening part of the filter assembly to combine with the base assembly, so that the filter assembly is fixed in the valve assembly.

2. The filtering device according to claim 1, wherein the base assembly comprises a lock part, and when the filter assembly is accommodated inside the valve assembly and the lock assembly is combined with the opening, the lock assembly drives the fastening part of the filter assembly to combine with the lock part of the base assembly.

3. The filtering device according to claim 2, wherein when the lock assembly is separated from the opening, the lock assembly drives the fastening part of the filter assembly to separate from the lock part.

4. The filtering device according to claim 2, wherein the fastening part comprises a first combination structure, the lock part comprises a second combination structure, and the filter assembly is movably combined with or separated from the second combination structure by the first combination structure, so as to combine with or separate from the base assembly.

5. The filtering device according to claim 1, wherein the filter assembly is a filter element.

6. The filtering device according to claim 1, wherein the lock assembly comprises a third combination structure formed at a side thereof, the valve assembly comprises a fourth combination structure formed on an internal wall of the opening and correspondingly in position to the third combination structure, and the lock assembly is movably combined with or separated from the fourth combination structure through the third combination structure, so as to combine with or separate from the valve assembly.
